(19) United States
(12) Patent Application Publication
(10) Pub. No.: US 2024/0053608 A1
(43) Pub. Date: Feb. 15, 2024

(54) AUGMENTED REALITY OPTICAL BLOCK

(71) Applicant: Vuzix Corporation, West Henrietta, NY (US)

(72) Inventors: Craig R. Travers, Honeoye Falls, NY (US); Robert W. Gray, Rochester, NY (US); Brian R. Mentz, Jacksonville, VT (US)

(21) Appl. No.: 18/096,376

(22) Filed: Jan. 12, 2023

Related U.S. Application Data
(60) Provisional application No. 63/299,243, filed on Jan. 13, 2022.

(51) Int. Cl. G02B 27/01

(52) U.S. Cl. CPC G02B 27/0172

(57) ABSTRACT

An augmented reality system comprising, a near-eye display operable to form virtual images viewable by a first of a wearer's eyes, the near-eye display located within a field of view of the first of the wearer's eyes, the near-eye display comprising an image generator operable to generate images, and, an optical block located within a field of view of a second of a wearer's eyes, wherein the optical block is operable to prevent a portion of environmental light from reaching a retina of the second of the wearer's eyes.

### TECHNICAL FIELD

The present disclosure relates generally to head-mounted displays and more particularly to near-eye display systems operable to convey image-bearing light to a viewer.

### BACKGROUND

Head-Mounted Displays (HMDs) and virtual image near-eye display systems are being developed for a range of diverse uses, including military, commercial, industrial, fire-fighting, and entertainment applications. For many of these applications, there is value in forming a virtual image that can be visually superimposed over the real-world image that lies in the field of view of the HMD or virtual image near-eye display system user. An optical image light guide, for example, may convey image-bearing light to a viewer in a narrow space for directing the virtual image to the viewer's pupil and enabling this superposition function. Certain HMDs and virtual image near-eye display systems are monocular augmented reality systems having an image generator forming a virtual image within the field of view of one eye, while the field of view of the other eye remains unencumbered.

Although humans have laterally separated eyes producing dual monocular input signals, individuals with normal binocular vision typically see images seamlessly blended into a combined binocular view. Visual data from each monocular input is received within the visual cortex of the brain and combined and processed by neurons called dominant eye columns. These dominant eye columns respond with a preference for one eye or the other. The extent of input from one eye dominating over another is known as “sensory eye dominance.” Sensory eye dominance can be problematic when using monocular near-eye display systems and other similar products. When viewing virtual content via a monocular near-eye display system, the brain may perceive an inconsistency of focus and attempt to focus or refocus the viewer's eyes. For example, while viewing a first object located behind a second object (i.e., viewing an object in the background behind a virtual object positioned in the foreground), the image of the first object may be doubled. The viewer's brain may attempt to refocus the images perceived by each eye, and this attempt to focus/refocus the viewer's eyes may create eye strain.

Thus, there is a need for a near-eye display system that reduces eye strain, double vision, and unfocused vision, and/or increases efficacy for users with diseases that affect vision, including but not limited to astigmatism and amblyopia.

### SUMMARY

One object of the present disclosure is to advance the art of monocular augmented reality systems. Advantageously, embodiments of the present disclosure provide solutions that are compatible with current head-mounted devices and virtual image near-eye display systems.

These and other aspects, objects, features and advantages of the present invention will be more clearly understood and appreciated from a review of the following detailed description of the preferred embodiments and appended claims, and by reference to the accompanying drawings.

According to one aspect of the present disclosure, there is provided an augmented reality system comprising a near-eye display operable to form virtual images viewable by a first of a wearer's eyes, the near-eye display located within a field of view of the first of the wearer's eyes; the near eye-display comprising an image generator operable to generate images; and an optical block located within a field of view of a second of a wearer's eyes, wherein the optical block is operable to prevent a portion of environmental light from reaching the retina of the second of the wearer's eyes. In an embodiment, the optical block is sized to be smaller than the near-eye display. In another embodiment, the optical block is sized to be substantially the same size as the near-eye display. The optical block, in one embodiment, may be semi-transparent. In another embodiment, the optical block is opaque. The position of the optical block can be a function of inter-pupillary distance between the first and second of the wearer's eyes. In an embodiment, the second of a wearer's eyes is the wearer's dominant eye. In another embodiment, the second of a wearer's eyes is the wearer's non-dominant eye.

### BRIEF DESCRIPTION OF THE SEVERAL VIEWS OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1A is a top view of a near-eye display positioned proximate and in relation to a first of a wearer's eyes according to an exemplary embodiment of the presently disclosed subject matter.

FIG. 1B shows a top view of a monocular augmented reality system having the near-eye display of FIG. 1A according to an exemplary embodiment of the presently disclosed subject matter.

FIG. 2 shows a front view of the monocular augmented reality system of FIG. 1B.

FIGS. 3A-3C show an optical block according to an exemplary embodiment of the presently disclosed subject matter.

FIGS. 4A-4B show an optical block according to another exemplary embodiment of the presently disclosed subject matter.

FIGS. 5A-5B show an optical block according to another exemplary embodiment of the presently disclosed subject matter.

FIG. 6 shows a perspective view of a monocular augmented reality system according to another exemplary embodiment of the presently disclosed subject matter.

FIG. 7 shows a perspective view of a portion of the monocular augmented reality system according to FIG. 6.

FIG. 8 shows a top view of the monocular augmented reality system according to FIG. 6.

FIGS. 9A and 9B show a front view of a monocular augmented reality system according to another exemplary embodiment of the presently disclosed subject matter.

FIG. 10 shows a liquid crystal matrix having an optical block according to an exemplary embodiment of the presently disclosed subject matter.

FIG. 11 shows a front view of a monocular augmented reality system according to another exemplary embodiment of the presently disclosed subject matter.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

One skilled in the relevant art will recognize that the elements and techniques described herein can be practiced without one or more of the specific details, or with other methods, components, materials, etc. In some instances, well-known structures, materials, or operations are not shown or described in detail to avoid obscuring certain aspects of the present disclosure. Reference throughout the specification to “one embodiment” or “an embodiment” means that a particular feature, structure, or characteristic described in connection with the embodiment is included in at least one embodiment of the present disclosure. Thus, the appearance of the phrase “in one embodiment” or “in an embodiment” throughout the specification is not necessarily referring to the same embodiment. However, the particular features, structures, or characteristics described may be combined in any suitable manner in one or more embodiments.

Where they are used herein, the terms “first”, “second”, and so on, do not necessarily denote any ordinal, sequential, or priority relation, but are simply used to more clearly distinguish one element or set of elements from another, unless specified otherwise.

Where used herein, the term “exemplary” is meant to be “an example of”, and is not intended to suggest any preferred or ideal embodiment.

Where they are used herein, the terms “viewer”, “wearer,” “swimmer”, “operator”, “observer”, and “user” are equivalent and refer to the person, or machine, who wears and views images using a monocular augmented reality system.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

Where used herein, the term “substantially” is intended to mean within the tolerance range of the equipment used to produce the value, or, in some examples, is intended to mean plus or minus 10%, or plus or minus 5%, or plus or minus 1%, unless otherwise expressly specified.

The term “set”, as used herein, refers to a non-empty set, as the concept of a collection of elements or members of a set is widely understood in elementary mathematics. The term “subset”, unless otherwise explicitly stated, is used herein to refer to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the term “coupled” is intended to indicate a physical association, connection, relation, or linking, between two or more components, such that the disposition of one component affects the spatial disposition of a component to which it is coupled. For mechanical coupling, two components need not be in direct contact, but can be linked through one or more intermediary components. A component for optical coupling allows light energy to be input to, or output from, an optical apparatus.

As an alternative to real image projection, an optical system, including, for example, a monocular augmented reality system can produce a virtual image display. In contrast to methods for forming a real image, a virtual image is not formed on a display surface. That is, if a display surface were positioned at the perceived location of a virtual image, no image would be formed on that surface. Virtual image displays have inherent advantages for augmented reality presentation. For example, the apparent size of a virtual image is not limited by the size or location of a display surface. Additionally, the source object for a virtual image may be small; a magnifying glass, as a simple example, provides a virtual image of its object. In comparison with systems that project a real image, a more realistic viewing experience can be provided by forming a virtual image that appears to be some distance away. Providing a virtual image also obviates the need to compensate for screen artifacts, as may be necessary when projecting a real image.

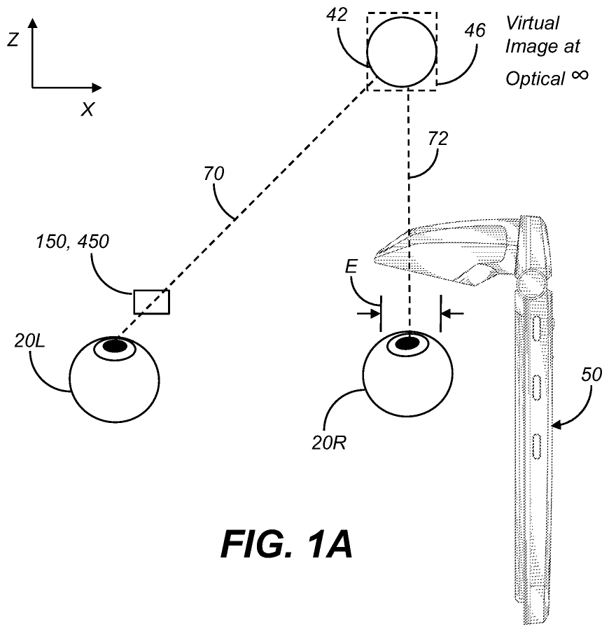

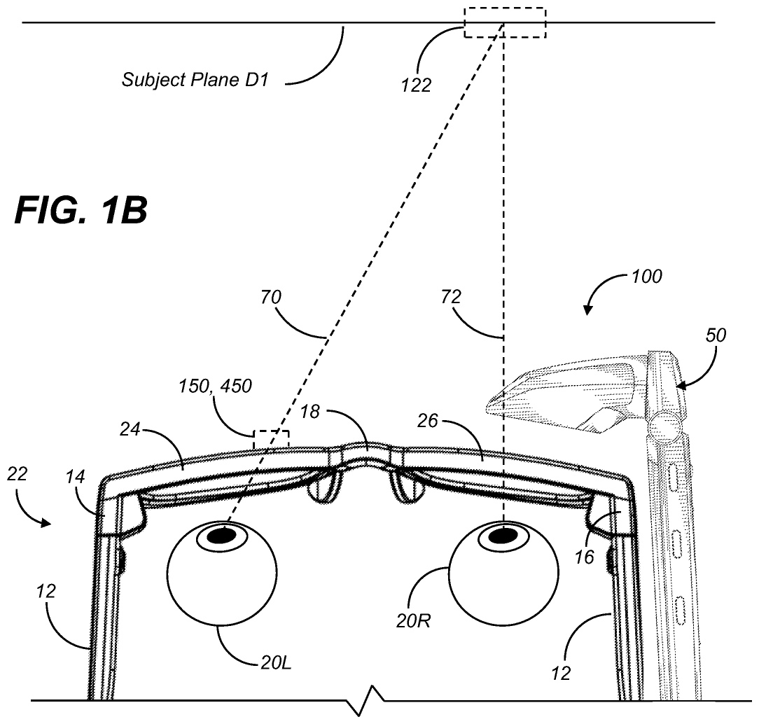

As illustrated in FIGS. 1A and 1B, in an embodiment, a monocular near-eye display system 50 is operable to direct image-bearing light to an eyebox E within which a virtual image 46 can be viewed. At the same time as the right eye 20R is viewing the virtual image 46 at optical infinity through the near-eye display system 50, the left eye 20L perceives the real-world scene that lies in the wearer's field of view. The left eye's 20L field of view overlaps the right eye's 20R field of view with respect to images formed by the monocular near-eye display 50. In this way, light received by the right eye 20R may form a virtual image 46 in the focal plane of objects 42. As shown in FIG. 1A, in an embodiment, the right eye 20R views the virtual image 46 at optical infinity along axis 72 while the left eye 20L views objects 42 at optical infinity along axis 70. As shown in FIGS. 1A and 1B, the optical block 150 prevents environmental image-bearing light corresponding to object 42 or environmental feature(s) 122, respectively, from entering the left eye 20L along axis 70. The position of the optical block 150 is a function of the position (e.g., optical infinity) of the virtual image 46 and the inter-pupillary distance between the wearer's right eye 20R and left eye 20L. The area and position of the blocked environmental image-bearing light corresponds to the size and position of the optical block 150. Subject plane D1, shown in FIG. 1B, illustrates a position of environmental objects/scenery located at optical infinity from the wearer.

The optical block 150 assists the brain in focusing on the virtual image 46, rather than the image of the environment feature(s) 122 that would otherwise be perceived by the left eye 20L. For example, where the left eye 20L is the wearer's dominate eye, the optical block 150 assists the brain in focusing on the virtual image 46 by depriving the brain of optical signals to the dominant eye in the corresponding area in which the non-dominate eye 20R receives image-bearing light corresponding to the virtual image 46. Alternatively, where the left eye 20L is the wearer's non-dominant eye, the optical block 150 assistants the brain in focusing on the virtual image 46 by depriving the brain of optical signals to the non-dominant eye in the corresponding area in which the dominant eye 20R receives image-bearing light corresponding to the virtual image 46. It should be appreciated that blocking either the dominant eye or the non-dominant eye may prevent, inter alia, distortion and eye strain.

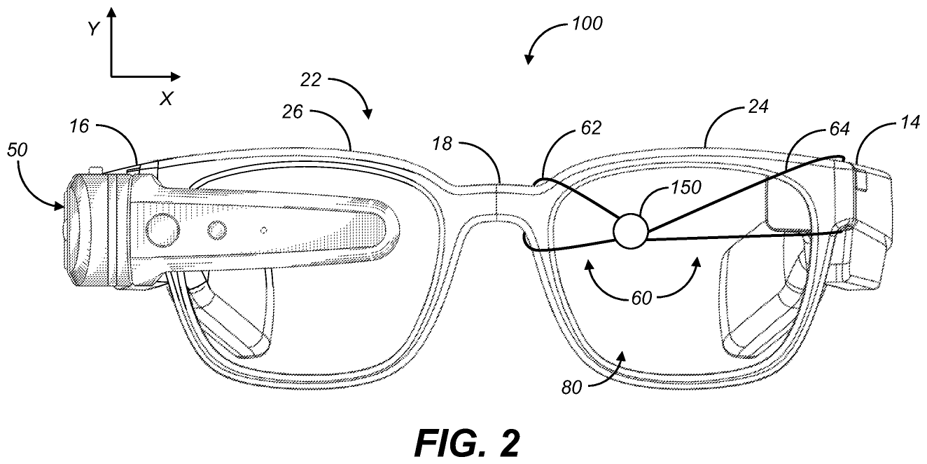

In an embodiment, as shown in FIGS. 1B and 2, a monocular augmented reality system 100 includes the near-eye display 50 coupled to an eyeglasses frame 22. For example, the near-eye display 50 may include a rail operable to engage with a corresponding rail-clip located on a temple 12 of the frame 22. It should be noted that while frame 22 is referred to as an eyeglasses frame, it is not required that every embodiment including the frame 22 also include lenses, and/or lenses having optical power mounted in the frame 22.

With continued reference to FIGS. 1B and 2, the optical path components, spacing, and constraints are described with reference to the right eye 20R. However, the same characteristics and constraints can apply to the left eye 20L, with parallel components and corresponding changes in component positioning. In an embodiment, the frame 22 includes temple members 12, rims 24, 26, and end pieces 14, 16 connecting the temples 12 with the rims 24, 26, respectively. A nose bridge 18 connects the rims 24, 26. As shown in FIG. 1B, the near-eye display 50 is mounted to the right temple member 12 to provide a virtual image viewable by a wearer's right eye 20R.

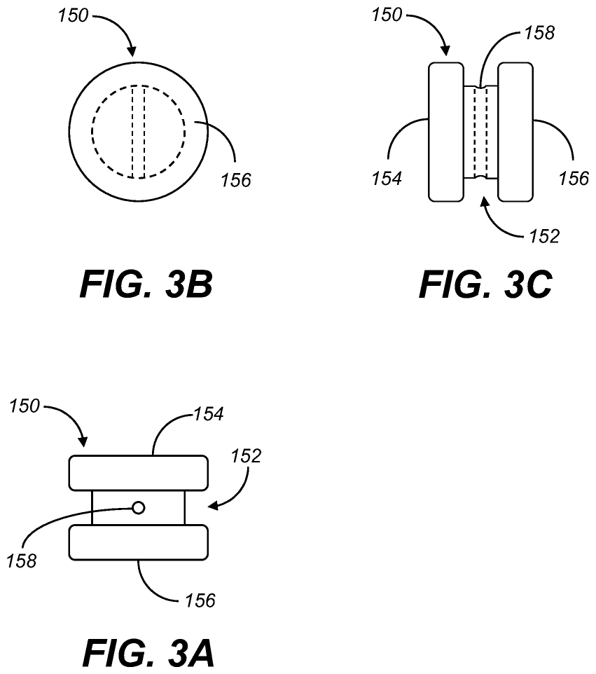

As illustrated in FIGS. 3A-3C, in an embodiment, the optical block 150 may comprise a generally cylindrical geometry having a groove 152 located about an outer surface thereof. For example, the optical block 150 may be a short cylinder having or approaching a generally disc or coin shape. In another embodiment, the optical block 150 may comprise a generally cuboid geometry. The optical block 150 may take a number of different forms, including, but not limited to, pyramidal, conical, frustopyramidal, frustoconical, spherical, and hemispherical. As illustrated in FIG. 2, in an embodiment, the optical block 150 is coupled with the frame 22 via a securement device 60. The securement device 60 holds the optical block 150 in a desired position in the field of view of the wearer of the monocular augmented reality system 100. For example, the securement device 60 may hold the optical block within the field of view of the left eye 20L through the left rim 24. In some examples, the shape of optical block 150 is selected to match the shape of an outline of the virtual image 46. For example, if an outline of the virtual image 46 is square, the shape of the optical block 150 should also be square. Matching the shape of the optical block 150 with the outline shape of the virtual image 46 prevents optical artifacts on the optical blocker 150 (e.g., jagged edges) from appearing with the virtual image 46.

In an embodiment, the securement device 60 comprises one or more elastomeric bands 62, 64. Where two or more bands 62, 64 are utilized to secure the optical block 150 to the frame 22, a first band 62 may be wrapped about a portion of the bridge 18 and/or the corresponding rim 24, 26 and at least partially located within the groove 152 of the optical blocker 150. A second band 64 may be wrapped about a portion of the end piece 14, 16 and/or the corresponding rim 24, 26 and also at least partially located within the groove 152.

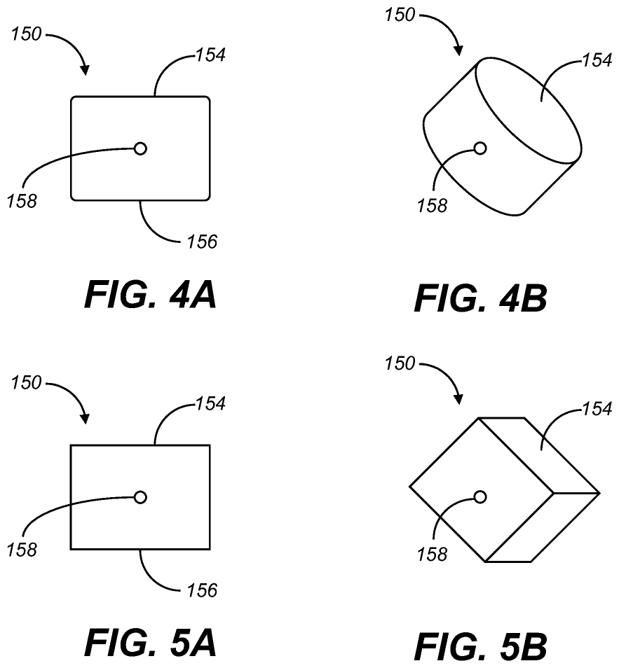

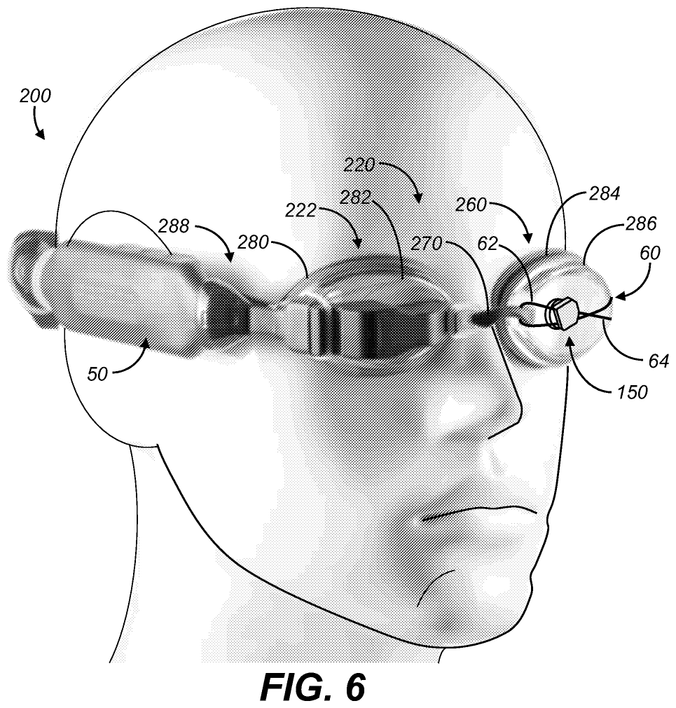

In an embodiment, the securement device 60 comprises a single band having a first end 62 and a second end 64. The band 60 may be wrapped around the optical blocker groove 152 one or more times and located about the bridge 18 and end piece 14, 16 in a similar manner as described with regard to the two-band embodiment above. In another embodiment, the band of the securement device 60 is located through a through-bore 158 in the body of the optical block 150. As illustrated in FIGS. 4A-5B, in such an embodiment, the optical block 150 need not include the groove 152. In another embodiment, the band(s) 62, 64 are non-elastic.

In an embodiment, the securement device 60 is adjustable without detaching the securement device 60 from the monocular augmented reality system 100 (as shown in FIG. 2). For example, the position of the optical block 150 may be changed to alter the portion of environmental light that is blocked from reaching the retina of the wearer's eye 20L. The adjustability of the position of the optical block 150 can enable users with different inter-pupillary distances to utilize the monocular augmented reality display system 100 with the optical block 150. The securement device 60 may be configured to slide along the continuous band, which increases the size of one loop and decreases the size of the other.

In an embodiment, the securement device 60 comprises an adhesive located on one or more surfaces 154, 156 of the optical block 150. The adhesive is operable to secure the optical block 150 to a transparent window or lens 80 within the rim 24, 26. For example, the adhesive may be a removable/temporary adhesive configured to provide a temporary bond between the optical block 150 and the transparent window/lens 80. In an embodiment, the removable/temporary adhesive is configured to repeatedly adhere the optical block 150 to the transparent window/lens 80, and therefore facilitate adjustment of the position of the optical block 150.

In an embodiment, the optical block 150 is mounted to the outside of the transparent window or lens 80 within rim 24, 26. In another embodiment, the optical block 150 is mounted to the inside of the transparent window or lens 80 within rim 24, 26. It should be noted that the optical block 150 can be any type of material or object capable of reducing, diminishing, or blocking at least a portion of light from the environment. For example, the optical block 150 can include, but is not limited to adhesive tape, paper, dye, pigment, paint, ink or other type of marking placed on or within the transparent window or lens 80 (as shown in FIG. 2). It should be appreciated that other types of optical blocks 150 that are not mounted on a frame, goggles, or a window positioned in front of the wearer's eye are possible. For example, a contact lens, with or without optical power, having a designated opaque or semi-transparent area could be used as an optical block 150. In an embodiment, the optical block 150 is opaque. However, it should be appreciated that the optical block 150 may comprise a semi-transparent substrate. In yet another embodiment, the optical block 150 includes an optical filter.

In an embodiment, the optical block 150 is positioned on the outside of the transparent window or lens 80. In another embodiment, the optical block 150 is positioned on the inside of the transparent window or lens 80. In an embodiment, the area of the optical block 150 is less than 50% of the area of the transparent window or lens 80, and is more preferably in the range of between 10% and 50% of the area of the transparent window or lens 80. In another embodiment, the area of the optical block 150 is selected from within a range of 15% and 40% of the area of the transparent window or lens 80. In yet another embodiment, the optical block 150 is generally the size (e.g., area) of the user's iris. In still another embodiment, the optical block 150 is generally smaller than the user's iris. In such an embodiment, the optical block 150 may only block a portion of the light reaching the user's eye to assist focus on the virtual image with reduced eye strain. Through experimentation, the inventors have found that embodiments of the optical block 150 which are generally black in color increase a user's ability to focus on the virtual image conveyed to the eyebox E.

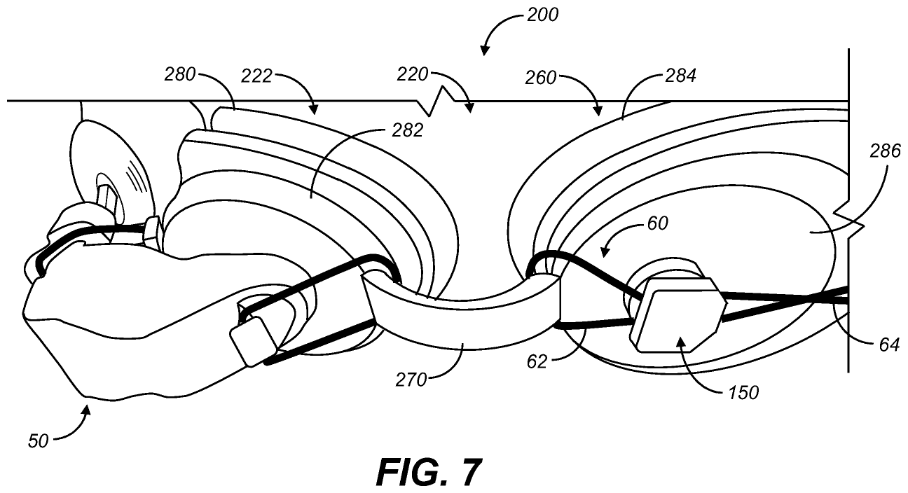

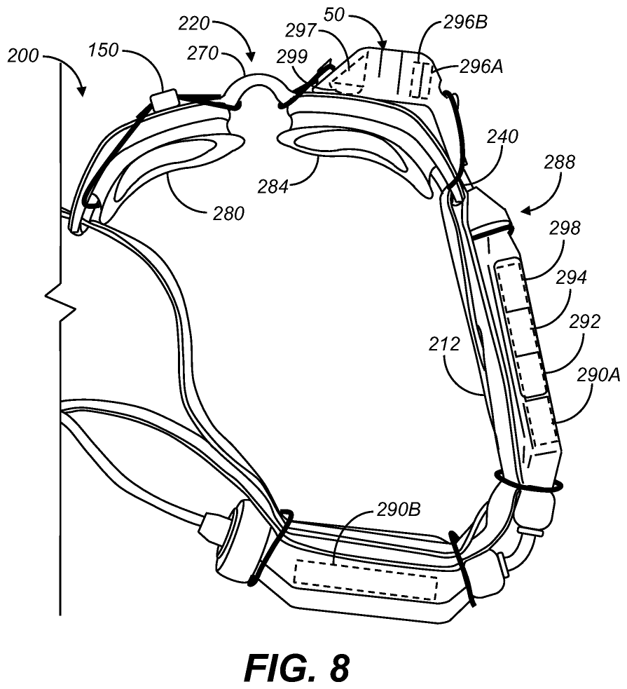

As illustrated in FIGS. 6-8, in another embodiment, the near-eye display 50 is coupled to goggles 220 to provide a monocular augmented reality system 200. It should be appreciated In the descriptions that follow, the optical path components, spacing, and constraints are described with reference to the right eye 20R of a viewer as represented in FIGS. 1A and 1B. The same characteristics and constraints can optionally apply for the left eye 20L, with parallel components and corresponding changes in component positioning.

In an embodiment, as shown in FIGS. 6-8, the monocular augmented reality system 200 includes goggles 220 having a flexible strap 212 that extends around the wearer's head to secure the goggles 220 to the wearer. The flexible strap 212 attaches to a right-eye covering 222 of the goggle display system and to a left-eye covering 260. The right-eye and left-eye coverings 220, 260 are coupled to one another via a nose bridge 270. In the embodiment, as illustrated in FIG. 6, the near-eye display 50 is attached to the right-eye covering 222 of goggles 220 for displaying a virtual image to the wearer. In an alternate embodiment, the near-eye display 50 is attached to the left-eye covering 260. In an embodiment, the near-eye display 50 is configured to be mounted on either side of the goggles 220 to allow the wearer to select a preferred side (e.g., where the near-eye display 50 is positioned over the wearer's right eye or left eye). In an embodiment, the near-eye display 50 is detachable from right-eye covering 222 and from flexible strap 212.

With continued reference to FIGS. 6-8, the right-eye covering 222 includes a seal 280 and a transparent window or plate 282. The seal 280 is operable to abut the wearer's skin and militates against the passage of water between the right-eye covering 222 and the skin of the wearer's face. Thus, the right-eye covering 222 generally isolates the right eye 20R from water when the wearer's face or head is underwater. Similarly, the left-eye covering 260 includes a seal 284 and transparent window or plate 286. The seal 284 is also operable to abut the wearer's skin and militates against the passage of water between the left-eye covering 260 and the skin of the wearer's face. Thus, the left-eye covering 260 generally isolates the left eye 20L from water when the wearer's face or head is underwater. Either or both transparent windows 282, 286 could be tinted or provide some type of light filtration. Either or both transparent windows 282, 286 may have optical power for vision correction.

In an embodiment, the near-eye display 50 is attached to a right temple region 288 of the strap 212 and the right-eye covering 222. The image-bearing light output of the near-eye display 50 is located across at least a portion of right transparent window 282 such that the near-eye display 50 is operable to convey image-bearing light to the right eye 20R within an eyebox. In an embodiment, the near-eye display 50 is attached to the right temple region 288, the bridge 270, and the right strap connection 240. In an embodiment, the near-eye display 50 is detachable from the right temple region 288, the right strap connection 240, and the bridge 270/right transparent window 282. In another embodiment, near-eye display 50 is molded as an integral part of at least one of the right temple member 288, the right strap connection 240, and the bridge 270/right transparent window 282. In an embodiment, the optical block 150 is positioned on the outside of the transparent window or plate 286. In another embodiment, the optical block 150 is positioned on the inside of the transparent window or plate 286. In an embodiment, the area of the optical block 150 is less than 50% of the area of the transparent window or plate 286, and more preferably is selected from within a range of 10% and 50% of the area of the transparent window or plate 286. In an embodiment, the area of the optical block 150 is selected from within a range of 15% and 40% of the area of the transparent window or plate 286.

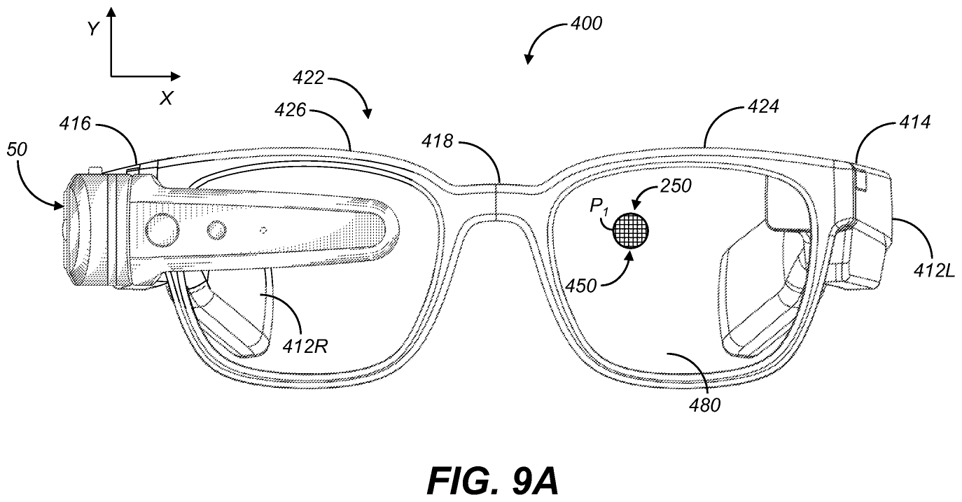

As shown in FIG. 8, in an embodiment, the near-eye display 50 includes one or more power supplies 290A, 290B, a wireless communication unit 292, a computational processing unit (CPU) 294, sensors 298, a micro-projection system having back lighting 296A and a display 296B operable to generate image-bearing light, and a prism 297. The display 296B is positioned at a distance from the prism 297 via an extension cavity therebetween to achieve the appropriate focal distance of the optical system. The prism 297 may include a mirrored surface operable to direct image-bearing light from the display 296B into an optic 299. In an embodiment, the optic 299 is a cylinder lens. It is to be understood that the back light 296A, the display 296B, the extension cavity, the prism 297, and the optic 299 are secured to a rigid frame within a water-tight enclosure. In another embodiment, the near-eye display 50 includes a waveguide operable to convey image-bearing light from a micro-projection system to the wearer's eye 20R. Persons skilled in the relevant art will recognize that the near-eye display 50 and the optical block 150 may be utilized with other types of goggles or head-mounted displays such as, but not limited to, sports goggles, racquet ball goggles, ski goggles, helmets, visors, etc.

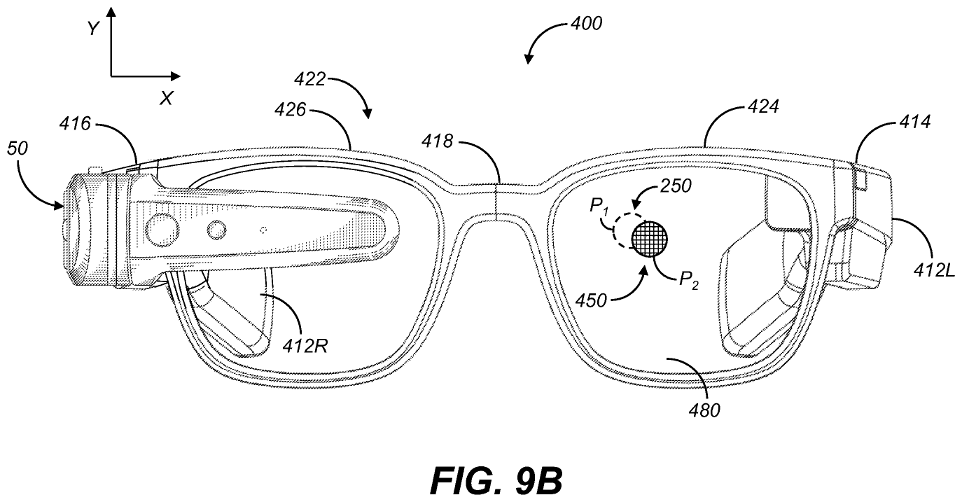

Referring now to FIGS. 9A-9B, in an embodiment, a monocular augmented reality display system 400 includes the near-eye display 50 coupled with an eyeglasses frame 422. For example, the near-eye display 50 may include a rail operable to engage with a corresponding rail-clip located on a temple 412R of the frame 422. The optical path components, spacing, and constraints of the monocular augmented reality display system 400 are described with reference to the right eye 20R; however, the same characteristics and constraints can apply to the left eye 20L, with parallel components and corresponding changes in component positioning. In an embodiment, the frame 422 includes temple members 412L, 412R, rims 424, 426, and end pieces 414, 416 connecting the temples 412 with the rims 424, 426, respectively. A nose bridge 418 connects the rims 424, 426. The near-eye display 50 may be mounted to the right temple member 412 to provide a virtual image viewable by a wearer's right eye 20R.

As illustrated in FIGS. 9A-11, in an embodiment, the optical block 450 is a liquid crystal matrix 250. In an embodiment, the liquid crystal matrix 250 is comprised of a plurality of pixels, wherein each pixel can be individually controlled. That is, a set of pixels of the liquid crystal matrix 250 is operable to rotate the polarization direction of the environmental light in a desired position along the liquid crystal matrix 250 similar in effect to a waveplate. As shown in FIG. 9A, in one embodiment, when the electric field is ON in the location of P₁, the environmental light in the area of P₁, comprising a plurality of pixels, is reduced, or blocked, from reaching the retina of the corresponding wearer's eye thereby providing the optical block 450. As shown in FIG. 9B, in an embodiment, when the electric field is ON in the location of P₂, the environmental light in the area of P₂, comprising at least some pixels different from the pixels of P₁, is reduced, or blocked, from reaching an optical neve of the corresponding wearer's eye thereby providing an optical block 450 in a different position from P₁. The optical block 450 may block a majority of ambient light incident thereon or only a portion of the light.

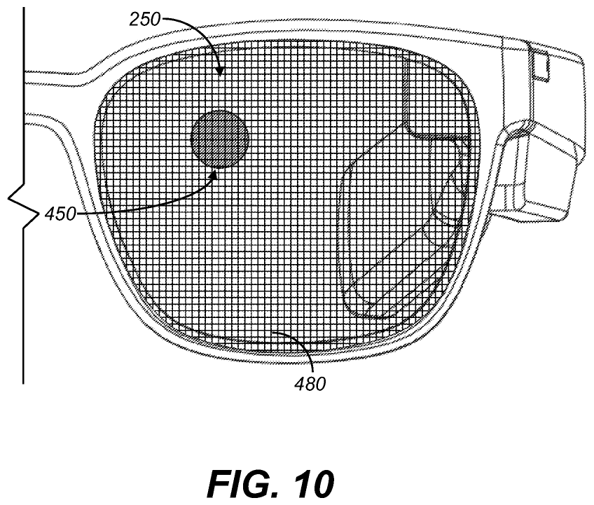

It should be appreciated that the entire transparent window 480 may include the liquid crystal matrix 250 as shown in FIG. 10. In an embodiment, only a portion of the transparent window 480 includes the liquid crystal matrix 250. In an embodiment, as shown in FIG. 10, the liquid crystal matrix 250 can be aligned within the transparent window 480 of the rim 424 to correspond with an area in which the wearer's right eye 20R receives image-bearing light corresponding to the virtual image 46. The position of the optical block 450 can be digitally aligned, for example, to move the optical block 450 from one position P₁ to a second position P₂ (as shown in FIG. 9B). In an embodiment, the optical block 450 can be digitally calibrated to provide a desired shape and size (e.g., diameter/area). In some examples, monocular augmented reality display system 400 also includes a controller having a processor and a non-transitory computer-readable memory arranged to execute and store, respectively, a set of instructions operable to adaptively energize the one or more pixels of the liquid crystal matrix 250. For example, the controller in a first step can determine the position of a field of view of the wearer's first eye viewing the virtual image at optical infinity formed by the virtual image near-eye display 50. The controller can further determine the size and shape of the field of view of the wearer's first eye viewing the virtual image. In an embodiment, the plurality of pixels form a generally circular optical block 450. In another embodiment, the optical block 450 is square, rectangular, elliptical, oval, or any other shape capable of being formed by a plurality of pixels in the liquid crystal matrix 250. It should be appreciated that the liquid crystal matrix 250 need not be a high-resolution display as it only needs to block or reduce light transmission through the area of the optical block 450. In an embodiment, the controller can be programed to adjust the opacity of the optical block 450.

In an embodiment, to determine the desired position of the optical block 450, the inter-pupillary distance between the first and second of the wearer's eyes 20R, 20L is calculated so that the position of the user's first and second eyes 20R, 20L are known. An optical block 450 is then placed at a position in front of the user's second eye that is dependent on the inter-pupillary distance and at a corresponding distance from the rim 424 of the frame 422, taking into consideration the size and shape of the liquid crystal matrix 250 such that at least a portion of the light emitted from a real object at the same location and focal distance as the virtual object are prevented from reaching the retina of the user's second eye.

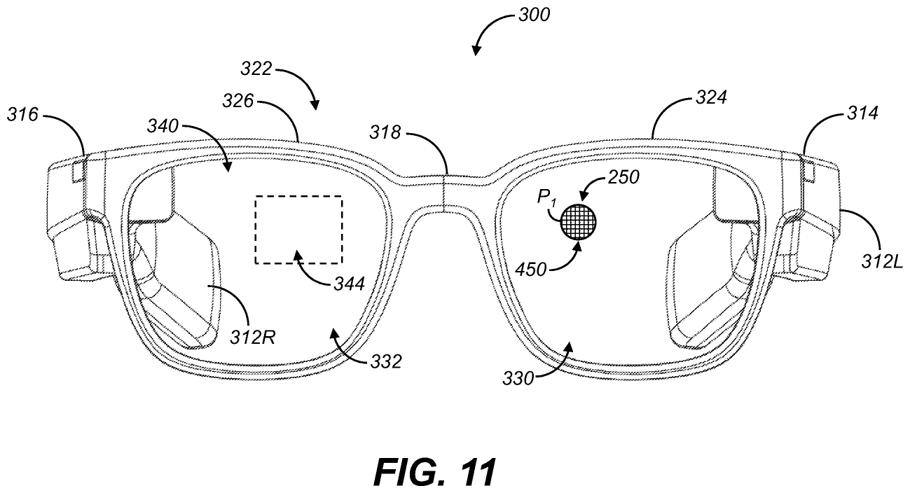

As illustrated in FIG. 11, in another embodiment, a monocular augmented reality system 300 includes a frame 322 having a nose bridge 318, rims 324, 326, and temple members 312R, 312L. Each rim 324, 326 at least partially surrounds a transparent window or plate 330, 332, respectively. At least one of the temple members 312 includes an image source. In an embodiment, the image source, is a picoprojector. In an embodiment, the transparent window 332 includes a planar waveguide 340 as further described in International Patent Application No. PCT/US2018/030821 and/or International Patent Application No. PCT/US2018/036999, incorporated by reference in their entirety. For example, the planar waveguide 340 includes an in-coupling diffractive optic and an out-coupling diffractive optic 344. Image-bearing light beams in-coupled into the waveguide 340 propagate by total internal reflection (TIR) to the out-coupling diffractive optic 344 and may be replicated via multiple encounters with an optical element to provide exit pupil expansion in one or more directions and directed out of the waveguide 340 to the eyebox. The diffractive optics encode and decode a real image generated by the image source as a set of angularly related image-bearing beams directed to a viewer's pupil. Other components used in augmented reality systems can be found in published United States Patent Application No. 2021/0103146 A1, which application is also incorporated by reference in its entirety.

As shown in FIGS. 9A-11, the optical block 450 comprising a liquid crystal matrix 250 may be utilized to assist the wearer in focusing on the virtual image by, for example, depriving the left eye 20L of optical signals in the corresponding area in which the right eye 20R receives image-bearing light corresponding to the virtual image. As described above, the position of the optical block 450 may be moveable to change the portion of environmental light that is blocked from reaching the retina of the wearer's eye left eye 20L. In an embodiment, the positioning of the optical block 450 is accomplished by programming the controller to change what is displayed in the liquid crystal matrix 250. It should be noted that although optical block 450 is shown, optical block 150 may alternatively be used with the monocular augmented reality system 300.

The optical block 450 assists the brain in focusing on the virtual image 46, rather than the image of the environment feature(s) 122 that would otherwise be perceived by the left eye 20L. For example, where the left eye 20L is the wearer's dominant eye, the optical block 450 assists the brain in focusing on the virtual image 46 by depriving the brain of optical signals to the dominant eye in the corresponding area in which the non-dominant eye 20R receives image-bearing light corresponding to the virtual image 46.

In an example embodiment, the optical block 150, 450 is a semi-transparent or semi-opaque area of the transparent window or lens 80, 330. For example, the optical block 150, 450 may be a tinted area of the transparent window or lens 80, 330. In an example embodiment, the optical block 150, 450 comprising a tinted area is arranged on or in a cover window of the augmented reality system. The optical block 150, 450 comprising a tinted area is operable to reduce the environmental light incident on the tinted area that reaches an optical neve of the corresponding wearer's eye.

The transparent window or lens described above, as well as a cover window, waveguide substrate, image light guide, or articulating arm may be referred to as a support configured to position the optical block 150, 450 within the field of view of the wearer's eye. It should be appreciated that the optical block 150, 450 described herein may be utilized with a number of HMD apparatus, including without limitation smart glasses, swimming goggles, ski goggles, protective eyewear, scuba masks, diving masks, helmet mounted displays, and HMD apparatus with a single continuous viewport for both eyes of a wearer.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. An augmented reality system, comprising:
a near-eye display operable to form virtual images viewable by a first of a wearer's eyes, the near-eye display located within a field of view of the first of the wearer's eyes;
the near-eye display comprising an image source operable to generate the virtual images; and
an optical block located within a field of view of a second of a wearer's eyes, wherein the optical block is operable to prevent a portion of environmental light from reaching a retina of the second of the wearer's eyes.

2. The augmented reality system of claim 1, wherein the second of the wearer's eyes is the wearer's dominant eye.

3. The augmented reality system of claim 1, wherein the second of a wearer's eyes is the wearer's non-dominant eye.

4. The augmented reality system of claim 1, wherein the optical block is smaller than the near-eye display.

5. The augmented reality system of claim 1, wherein the optical block is semi-transparent.

6. The augmented reality system of claim 1, wherein the optical block is opaque.

7. The augmented reality system of claim 1, wherein the optical block is black.

8. The augmented reality system of claim 1, wherein the position of the optical block is a function of inter-pupillary distance between the first and second of the wearer's eyes.

9. The augmented reality system of claim 1, wherein the optical block is formed by at least a portion of a liquid crystal matrix.

10. The augmented reality system of claim 1, wherein the optical block is arranged along a surface of a transparent window or plate, and wherein the optical block comprises a groove arranged to receive at least a portion of a securement device.

11. The augmented reality system of claim 1, wherein the optical block is arranged along a surface of a transparent window or plate, and wherein the optical block comprises a through-bore arranged through at least a portion of the optical block, wherein the through-bore is arranged to receive at least a portion of a securement device.

12. The augmented reality system of claim 1, wherein the optical block is secured to a first transparent window or plate of the augmented reality system via an adhesive material.

13. The augmented reality system of claim 1, wherein the near-eye display is removably secured to an eyeglass frame or a pair of goggles.

14. The augmented reality system of claim 13, wherein the optical block is configured to engage with the eyeglass frame or pair of goggles via a securement device, wherein the securement device comprises a first end arranged to be secured about at least a portion of a nose bridge of the eyeglass frame or the pair of goggles, and a second end arranged about an end piece of the eyeglass frame or pair of goggles.

15. The augmented reality system of claim 14, wherein a length of the first end and/or the length of the second end of the securement device is increased or decreased to alter a position of the optical block within a user's field of view.

16. An augmented reality system, comprising:
a near-eye display operable to form virtual images viewable by a first of a wearer's eyes, the near-eye display located within a field of view of the first of the wearer's eyes;
the near-eye display comprising an image source operable to generate the virtual images at optical infinity; and
a support having an optical block, the optical block located within a field of view of a second of a wearer's eyes which overlaps with the field of view of first of the wearer's eyes, wherein the optical block is operable to at least partially reduce a portion of environmental light from reaching a retina of the second of the wearer's eyes.

17. The augmented reality system of claim 16, wherein the optical block is a liquid crystal matrix comprising a plurality of pixels, wherein a set of pixels is operable to rotate the polarization direction of the environmental light in a desired position along a portion of the liquid crystal matrix to reduce environmental light from reaching the retina of the second of the wearer's eyes.

18. The augmented reality system of claim 16, wherein the support is a window and wherein the optical block is a substrate mounted to the window.

19. The augmented reality system of claim 17, wherein the optical block is configured to move from one position to a second position.

20. The augmented reality system of claim 17, wherein the size and shape of the optical block is adjustable.
